(19) United States
(12) Patent Application Publication
(10) Pub. No.: US 2004/0035522 A1
(43) Pub. Date: Feb. 26, 2004

(54) Method of producing christmas tree decorations and other decorative items of thin-walled blown glass

(76) Inventors: Robert Mostowski, Czestochowa W. Utansha (PL); Stanistaw Kaminski, Czestochowe Al. Wyzwolenie (PL)

Correspondence Address: Joseph Sofer, Sofer & Haroun, Suite 910, 317 Madison Avenue, New York, NY, 10017, US

(21) Appl. No.: 10/450,557

(22) PCT Filed: Jan. 17, 2001
(86) PCT No.: PCT/PL01/00005

(30) Foreign Application Priority Data
Dec. 15, 2000 (PL) P.344622

(51) Int. Cl. B32B 35/00

(52) U.S. Cl. 156/242

(57) ABSTRACT

The method of producing Christmas tree decorations as well as other decorative items from thin-walled blown glass where the suspension or the fastening axis of the decorative item is located on the blowing axis or outside the blowing axis consists in shaping, after plastification and blowing, of the glass bulb through the stay (4) in order to represent the inside of the mould in the first stage of blowing with the shaping limitations of the shell obtained. Inside the mould (1) there is a closed shaping element in the form of a protrusion (9) which serves the balanced fastening of the hanging element in the first stage of blowing as well as a protrusion (6) for bonding the subsequent elements of the decorative item. The closed protrusion for bonding is secured with a symmetric (3) or an asymmetric (16) plug. Following the removal of the shell from the mould (1), the protrusion (6) opens and a piece of pipe (7) is bonded with that opening on the outside of the protrusion; the opening seais and then that piece of pipe is plastitied, it is inserted back in the mould (1) with the plug removed and is blown to obtain the final shape by the full representation of the inside of the mould, while after each heating stage the glass is annealed.

The invention concerns the method of manufacture of glass shells of Christmas tree decorations and similar decorative items manufactured from thin-walled blown glass and serving as decorative elements, advertising and special occasion decorations.

A method of manufacturing of glass shells of Christmas tree decorations is known from, for example, a Polish patent description no 171623 and it consists in shaping from the glass semi-product of a bulb with two stays: the main one and the supporting one which, after plastification, is placed in a mould and blown, then the supporting stay is annealed, burned off and sealed and the main stay is removed following the placement of the bulb in a holder, the whole is annealed; during the blowing the bulb acquires an additional element in the form of a venting protrusion located on one of the longer walls which, after the annealing of the shell is opened while the opening of the main stay is sealed.

The existing method of producing Christmas tree decorations and other ‘double formed’decorative items of thin-walled blown glass consists in that a glass pipe of one type and one diameter is plastified yielding a semi-finished product referred to as an‘olive’which is at one end sealed with the supporting stay or without such a stay and with the main stay used for blowing the other end. A part of the olive is plastified, inserted in the mould and blown to obtain the representation of the mould. The next, second forming operation is the plastification of the other part of the olive, inserting it into another, different mould and blowing. This is the way Christmas tree decorations and other decorative items consisting of different shapes of similar sizes are made, which may be obtained by blowing the particular parts of the olive in at least two different moulds which give the glass shell particular shapes while the hanging point of the decorative element will be located on its blowing axis.

The repeatedly formed decorative items consisted of shapes of similar size connected with each other in one blowing and hanging axis.

The disadvantage of the hereto used methods of manufacture of Christmas tree decorations and other thin-walled blown glass decorative items are difficulties in producing the narrowings of the shapes in places where the figure created from the developed shape is to assume the narrowing beyond which the next spatial development is to take place, which requires using more than one forming mould.

The aim of the present invention is to broaden the assortment of Christmas tree decorations and other thin-walled blown glass decorative items with varied shapes manufactured using only one forming mould whose interior is appropriately shaped and prepared, which is of special importance if the body of the decorative element has narrowings between the parts with spatially developed and varied shapes. It also allows to make an open protrusion for the balanced fastening of a hanging element of the decorative element in any place and the hanging and fastening axis may be located on the blowing axis or outside it.

The mould shaping the representation of the interior through blowing of the plastified olive has appropriately formed plugs in the defined places which may be symmetric or asymmetric whose construction accounts for the shapes of the decorative element which prevent the plastified glass from flowing into predefined shape elements inside the mould. In the mould there is an additional shaping element in the form of a protrusion which serves the balanced fastening of the hanging element in the case the hanging decorative item is manufactured or for bonding the subsequent elements giving the glass decorative item the defined final shape. Following the removal of the plugs and the opening of the protrusions a piece of a glass pipe is bonded outside the protrusion thus created, which is then sealed, burned or cut off. Another operation is the plastification of the connected glass pipe and the repeated insertion of the glass shell with removed plugs to the mould and the final blowing and shaping of the shapes put together earlier. At each heating stage the glass is annealed.

The invention has been presented in the drawing where

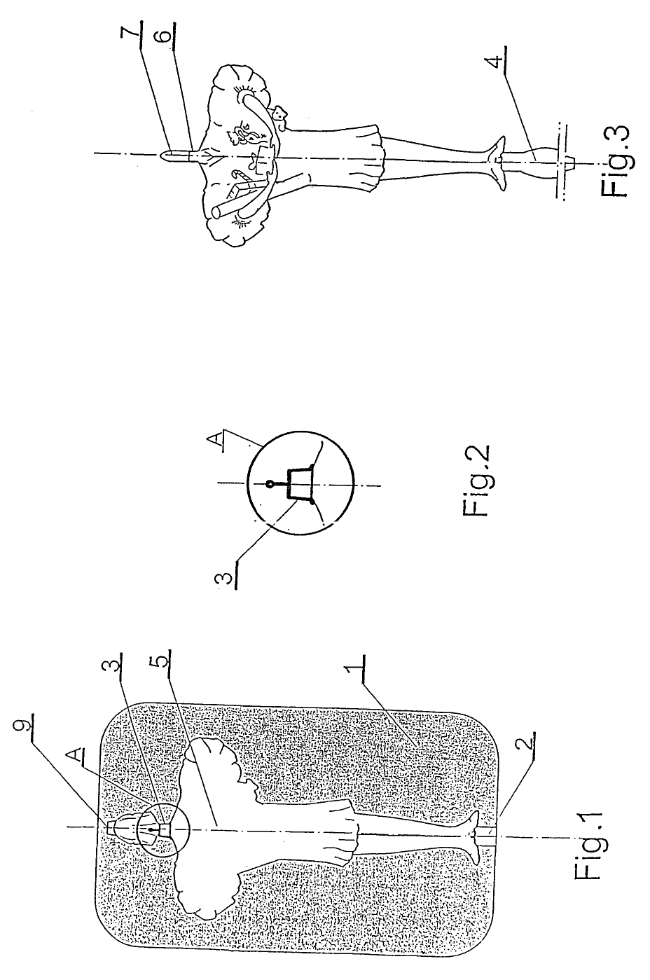

FIG. 1 presents the lower part of the mould for initial blowing where the hanging or the fastening axis of the decorative item corresponds to the blowing axis,

FIG. 2 presents the symmetric plug and its location limiting the blowing in the first stage of forming of the decorative item,

FIG. 3 presents the partly shaped figure with a bonded glass pipe for further bowing,

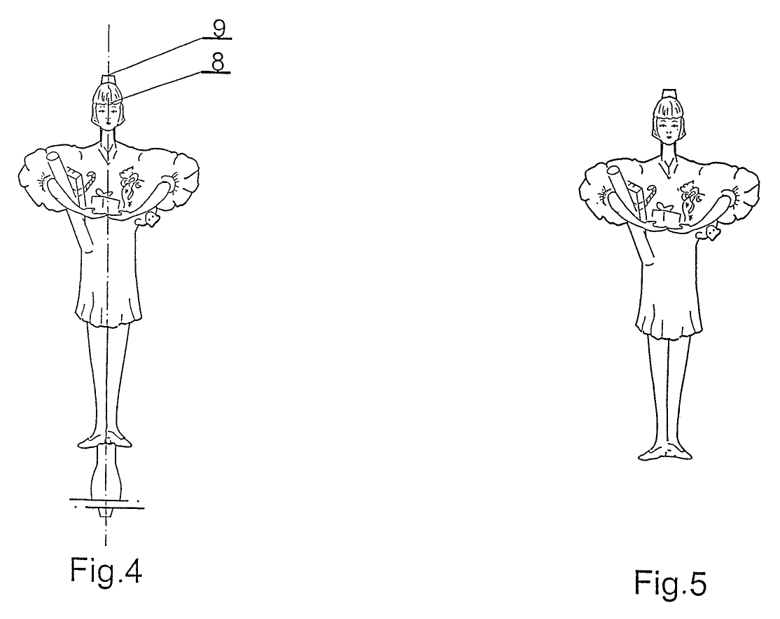

FIG. 4 presents a mould with a fully shaped figure and the stay for blowing,

FIG. 5 presents the finished raw figure obtained from the thin-walled blown glass in two forming stages following the removal and the sealing of the main stay,

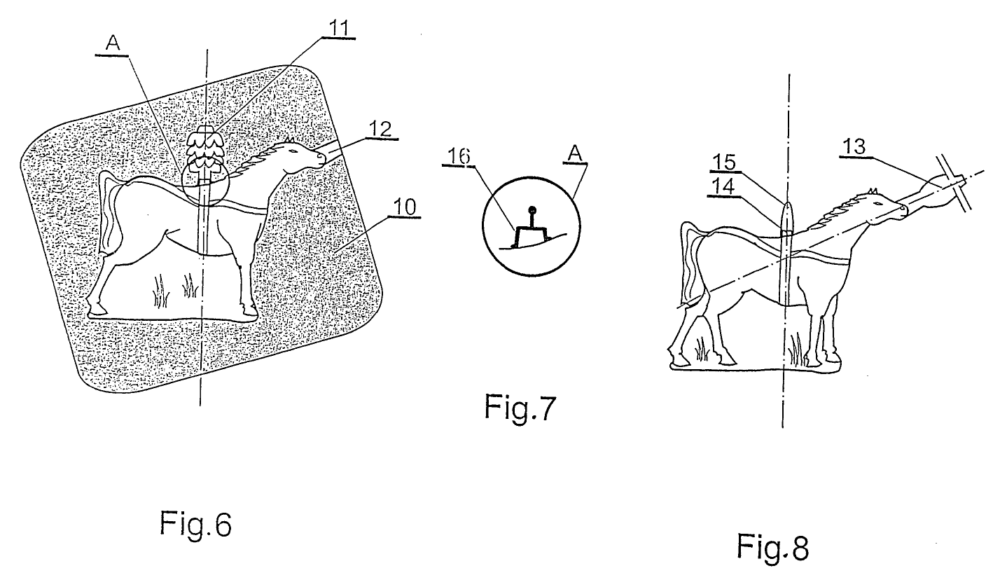

FIG. 6 presents the lower part of the mould for initial blowing where the hanging or the fastening axis of the decorative item is outside the blowing axis,

FIG. 7 presents the asymmetric plug adjusted to the shape of the blown figure,

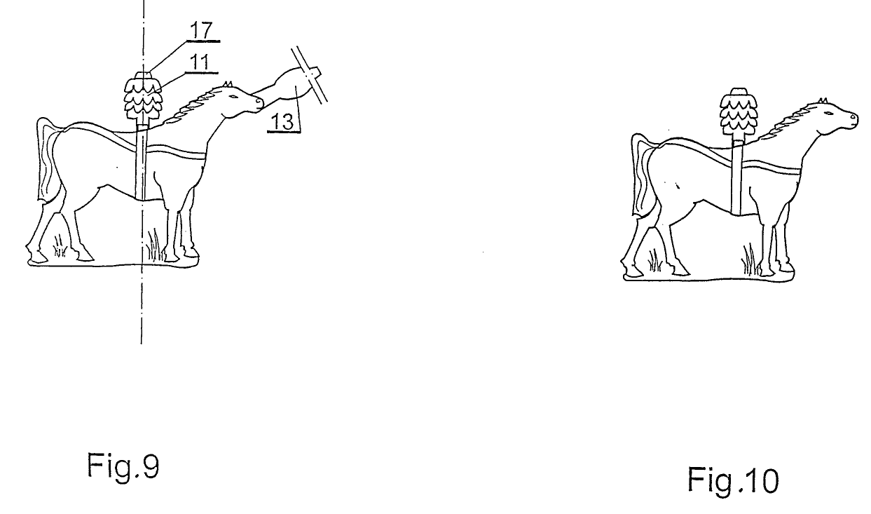

FIG. 8 presents a partly shaped figure with a visible main stay and a glass pipe connected by bonding which serves further blowing,

FIG. 9 presents a mould with a fully shaped figure and the main stay and

FIG. 10 presents a finished raw shell of thin-walleci blown glass obtained in two forming stages, but in one mould, following the removal and the sealing of the main stay.

The method of manufacture of Christmas tree decorations and other decorative items of thin-walled blown glass according to the invention has been illustrated in the examples below.

### EXAMPLE 1

The hanging or the fastening axis of the decorative item is located in the blowing axis. Mould 11/has been prepared to blow a figure of a tall slim girl with a bunch of different presents of varied shapes, the girl has slim legs, a thin neck, a proportionally small head with a protrusion on its top.

The opening in the mould where the main blowing stay/2/is placed has been placed under the girl's legs and a symmetric plug/3/with a formed protrusion has been placed in her neck. 110 mm of the glass semi-finished product in the form of a glass pipe with a diameter of 30 mm has been plastified. At one end the glass pipe has been sealed and at the other a thickened main stay 141 with a narrowing has been created. The thus created semi-finished product has been plastified, inserted in the mould/1/and blown. At this stage a blown figure of a girl/5/was created with a bunch of presents, but without a head; the figure is equipped in a protrusion/6/for fastening the glass pipe/7/. Such a semifinished product has been annealed, then on the top of the protrusion 161 an opening has been made and the whole has been annealed again. The symmetric plug/3/has been removed from the mould, the end of the new glass pipe 171 with a diameter of 10 mm has been plastified; at the same time the protrusion/6/has been plastified as well. The glass pipe/7/has been connected to the body/5/through being bonded outside the opening in the protrusion 161. On the length of approximately 30 mm the glass pipe/7/is sealed and the stay of that pipe is burned off, then the pipe is plastified. The next operation is the repeated insertion of the thus prepared glass shell 151 with a connected glass pipe 171 into the mould and the final blowing of the girl's head/8/with a protrusion 191 for fastening the hanging element. After the complete figure has been blown, it is removed from the mould, annealed, the protrusion/9/in the girl's head/8/is opened thus creating a place for fastening the hanging element, while the main stay/4/is sealed and cut off.

Thus a Christmas tree decoration has been obtained in the form of a girl's figure whose shapes are varied, have many narrowings and which has a balanced place for fastening the hanging element which is in the axis of the decorative element's blowing.

### EXAMPLE II

The hanging or the supporting axis of the decorative item is outside the blowing axis. The mould/10/has been prepared for blowing a figure of a circus horse with a panache on its back/l /where the protrusion for fastening the hanging element is located. The blowing opening in the mould/12/is located in the horse's head. 100 mm of the glass semi-finished product in the form of a glass pipe with a diameter of 35 mm has been plastified, the pipe has been sealed at one end and at the other end the main stay was created. The thus shaped semi-finished product has been plastified, inserted into the prepared mould with an asymmetric plug/16/and blown through the main stay/13/yielding a shell in the shape of a horse with a protrusion/14/on its back, but without the panache. The shell has been annealed, an opening has been made on the top of the protrusion/14/on the horse's back, the whole has been annealed again. The shell has been fastened in the holder to plastify the protrusion/14/. The asymmetric plug/16/has been removed from the mould, the ending of a new glass pipe/15/with the diameter of 12 mm has been plastified, simultaneously, the protrusion/14/has been heated. The glass pipe/15/has been connected with the protrusion/14/ on the shell by sealing it on the outside of the opening in the protrusion. The glass pipe/15/has been sealed on the length of 25 mm and plastified, then the shell with the raw plastified glass pipe/15/is inserted back into the mould and blown to form a panache/11/on the horse's back with a protrusion/17/which will serve for the fastening of the hanging element. The main stay/) 3/ has been sealed and thus a raw decorative item of thin-walled blown glass with varied dimensions and shapes has been obtained where the figure narrowings have been considered and which has a balanced spot for fastening the hanging element, which is located outside the blowing axis.

The above method simplifies the production of decorative items of thin-walled blown glass using one mould to obtain complex and varied shapes, including the narrowings, of the raw glass shells which are later on subjected to further decorative operations.

What is claimed as:

1. A method of producing multiple element, thin walled, blown glass ornaments in a mold, said method comprising the steps of:
blowing a glass bulb inside of said mold through a stay, so as to form a first element of said blown glass ornament, said first element of said ornament having a first protrusion formed thereon;
blowing in said stay so as to form at least a second element of blown glass inside said mold, said second element of blown glass being supported on said first protrusion of said first element, said second element having a second protrusion formed thereon.

2. The method as claimed in claim 1, wherein said second protrusion on said second element is formed in the blowing axis of said stay.

3. The method as claimed in claim 1, wherein said second protrusion on said second element is formed outside of the blowing axis of said stay.

4. The method as claimed in claim 1, further comprising the step of placing a symmetric plug in said mould, so that when said first element is blown in said mold said first protrusion is formed in said first element in the shape of said symmetric plug.

5. The method as claimed in claim 1, further comprising the step of placing an asymmetric plug in said mould, so that when said first element is blown in said mold said first protrusion is formed in said first element in the shape of said asymmetric plug.

6. The method as claimed in claim 1, further comprising the steps of bonding a glass pipe to said first protrusion and returning said first element to said mold so as to form said second element by blowing through said stay and said glass pipe.

7. The method as claimed in claim 4, wherein after said step of removing said symmetric plug, a glass pipe is bonded to said first protrusion and said first element is returned to said mold so as to form said second element by blowing through said stay and said glass pipe attached to said first protrusion.

8. The method as claimed in claim 5, wherein after said step of removing said asymmetric plug, a glass pipe is bonded to said first protrusion and said first element is returned to said mold so as to form said second element by blowing through said stay and said glass pipe attached to said first protrusion.

9. The method as claimed in claim 1, wherein said second protrusion serves for the balanced fastening of a hanging element on said decoration.
